(19) United States
(12) Patent Application Publication
(10) Pub. No.: US 2022/0206516 A1
(43) Pub. Date: Jun. 30, 2022

(54) MECHANICAL CRYOGENIC TEMPERATURE SENSOR AND ACTUATOR

(71) Applicant: L'Air Liquide, Société Anonyme pour l'Etude et l'Exploitation des Procédés Georges Claude, Paris (FR)

(72) Inventors: Ren Chen, Hangzhou (CN); Hai-Da Chen, Hangzhou (CN)

(21) Appl. No.: 17/135,639

(22) Filed: Dec. 28, 2020

(51) Int. Cl. G05D 7/01

(52) U.S. Cl. CPC G05D 7/01; E03F 5/041

(57) ABSTRACT

An apparatus for controlling fluid flow, including a temperature sensitive material, having a first physical property at a first temperature and a second physical property at a second temperature, a device for controlling fluid flow, and a device for connecting the temperature sensitive material to the fluid flow control device. The connecting device may be configured so that the fluid flow control device is in a first position at the first temperature and in a second position at a second temperature. The temperature sensitive material may be aluminum wire or stainless steel wire. The temperature sensitive material may have the shape of an Archimedean spiral. The connecting device may be a motion amplifier. The first temperature may be a cryogenic temperature.

### BACKGROUND

In an industrial facility cryogenic liquid spillage into a rainwater drain network system can be very dangerous. It may cause a fire or an asphyxia incident in public or an industrial area. Normal industrial practice has been a water siphon system. In such a system, a volume of water is maintained in a drain basin. This drain basin is connected to the drain network system. Under normal conditions, rainwater, or any runoff water, drains into the ran basin, then into the drain network system. However, in the event of a cryogenic liquid spill, as the cryogenic liquid enters the drain basin the standing water present will freeze, and ultimately the cryogenic liquid will vaporize. This prevents the liquid cryogen from entering the drain network system.

Such a system requires that a volume of water be maintained in the drain basin. In some hot and dry areas, such as Northern China, the water will tend to vaporize quickly and there is a risk of the basin running dry. Hence, there is a need in such areas to periodically refill the basin with water.

Therefore, there is a need in the industry for a purely mechanical mechanism mainly that can operate without water. Such a system may be advantageous in the following situations. In situations as described above, wherein rainwater drain networks utilize wet seals, which may periodically run dry. In situations including a cryogenic liquid vaporizer chimney bottom pit, wherein such a system may find water accumulating due to a high-water table present in the area. Or other applications for low temperature detection without electrical power, such as a flat bottom tank area spillage detection system.

### SUMMARY

An apparatus for controlling fluid flow, including a temperature sensitive material, having a first physical property at a first temperature and a second physical property at a second temperature, a device for controlling fluid flow, and a device for connecting the temperature sensitive material to the fluid flow control device. The connecting device may be configured so that the fluid flow control device is in a first position at the first temperature and in a second position at a second temperature. The temperature sensitive material may be aluminum wire or stainless steel wire. The temperature sensitive material may have the shape of an Archimedean spiral. The connecting device may be a motion amplifier. The first temperature may be a cryogenic temperature.

### BRIEF DESCRIPTION OF THE FIGURES

For a further understanding of the nature and objects for the present invention, reference should be made to the following detailed description, taken in conjunction with the accompanying drawings, in which like elements are given the same or analogous reference numbers and wherein:

FIG. 1 is a schematic representation a temperature sensor, in accordance with one embodiment of the present invention.

FIG. 2 is a schematic representation a temperature sensor, illustrating the spiral shape and sensor guides, in accordance with one embodiment of the present invention.

FIG. 3a is a schematic representation a temperature sensor, illustrating the first, or “hot” position of the trigger ring, in accordance with one embodiment of the present invention.

FIG. 3b is a schematic representation a temperature sensor, illustrating the second, or “cold” position of the trigger ring, in accordance with one embodiment of the present invention.

FIG. 4a is a schematic representation a temperature sensor, illustrating the sensor guides, in accordance with one embodiment of the present invention.

FIG. 4b is a schematic representation of the sensor guides, in accordance with one embodiment of the present invention.

FIG. 5a is a schematic representation illustrating the trigger ring in position relative to the trigger as would be under normal operating conditions, in accordance with one embodiment of the present invention.

FIG. 5b is a schematic representation illustrating the trigger ring in position relative to the trigger as would be under cryogenic spill conditions, in accordance with one embodiment of the present invention.

FIG. 6 is a schematic representation a temperature sensor system under normal operating conditions, in accordance with one embodiment of the present invention.

FIG. 7 is a schematic representation a temperature sensor system under rainwater drain conditions, in accordance with one embodiment of the present invention.

FIG. 8 is a schematic representation a temperature sensor system under cryogenic spill conditions, in accordance with one embodiment of the present invention.

FIG. 9a is a schematic representation illustrating the micro-displacement magnification system with the trigger ring in position relative to the trigger as would be under normal operating conditions, in accordance with one embodiment of the present invention.

FIG. 9b is a schematic representation illustrating the micro-displacement magnification system with the trigger ring in position relative to the trigger as would be under cryogenic spill conditions, in accordance with one embodiment of the present invention.

FIG. 10 is a schematic representation a temperature sensor system under normal operating conditions, in accordance with one embodiment of the present invention.

FIG. 11 is a schematic representation a temperature sensor system under rainwater drain conditions, in accordance with one embodiment of the present invention.

FIG. 12 is a schematic representation a temperature sensor system under cryogenic spill conditions, in accordance with one embodiment of the present invention.

### ELEMENT NUMBERS

101=Temperature Sensor
102=Inner Wire
103=Teflon Tube
104=Outer Tube
105=Anchor Point
106=Trigger Ring
107=Sensor Guides
108=Trigger
109=Grate
110=Collection Chamber
111=Drain Plug
112=Drain Plug Spring
113=Outlet Chamber
114=Outlet
115=Cryogenic Liquid
116=Rainwater
117=Hinge Point
118=First Sliding Point
119=Second Sliding Point
120=Trigger Bar
121=Lever
122=Sensor Guide Slots

### DESCRIPTION OF PREFERRED EMBODIMENTS

Illustrative embodiments of the invention are described below. While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

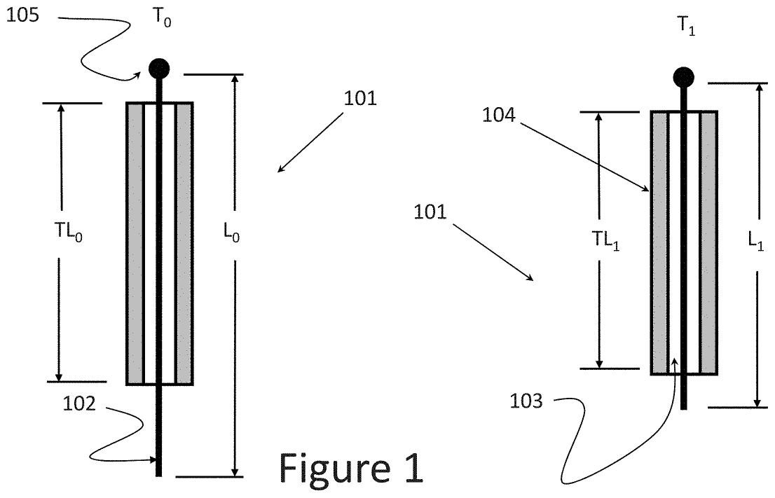

Turning to FIG. 1, temperature sensor 101 includes an outer tube 104 and an inner wire 102. Temperature sensor 101 may also include a polytetralfluoroethylene (Teflon®) tube 103. One end of inner wire 102 has an anchor point 105. At time=T₀, temperature sensor 101 has an overall length of L₀. As temperature sensor 101 experiences a reduction in temperature, at time=T₁, the overall length L₁ has changed, due to thermal contraction. Outer tube 104 will also experience a change in overall length from TL0 to TL1 as temperature sensor 101 experiences a reduction in temperature. However, outer tube 104 is composed of a different material from inner wire 102, and will experience much less change.

Aluminum has a coefficient of linear thermal expansion of between 21 and 24 [10⁻⁶ m/(m ° C.)]. Carbon Steel has a coefficient of linear thermal expansion of between 10.8 and 12.5 [10⁻⁶ m/(m ° C.)]. Stainless Steel has a coefficient of linear thermal expansion of between 9.9 and 17.3 [10⁻⁶ m/(m ° C.)]. And, Invar has a coefficient of linear thermal expansion of 1.5 [10⁻⁶ m/(m ° C.)].

Therefore, utilizing a tube made of any material except for Invar would result in outer tube 104 expanding very nearly as much as inner wire 102. As will be obvious as the instant invention is described in detail, this would not be desirable and may render the device unusable. However, Invar has a very low coefficient of linear thermal expansion, and only contract only about 1/15 as much as Aluminum, ⅛ as much as Carbon Steel, and 1/10 as much as Stainless Steel. Therefore, it is preferred that outer tube 104 be made of Invar. In one embodiment, inner wire 102 is made of stainless steel and outer tube 104 is made of invar. In another embodiment, inner wire 102 is made of Aluminum and outer tube 104 is made of invar. In yet another embodiment, inner wire 102 is made of carbon steel and outer tube 104 is made of invar.

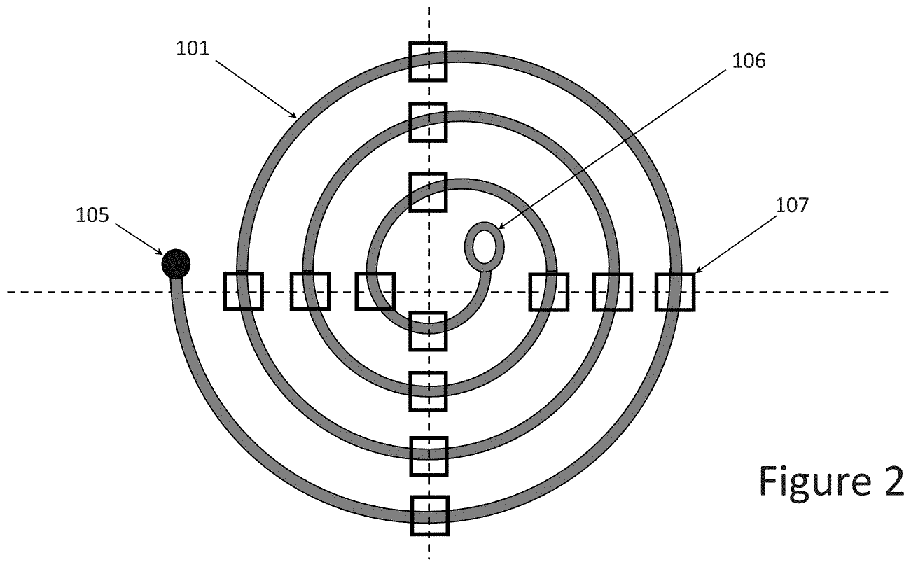

Turning to FIGS. 2, 3a, 3b, 4a, and 4b, one embodiment of temperature sensor 101 is presented. In this embodiment, temperature sensor 101 is in the shape of a spiral, preferably an Archimedean spiral. This is a shape that efficiently allows a fairly long temperature sensor 101 to be utilized in a fairly compact space. One end of temperature sensor 101 is fixed at anchor point 105. As temperature sensor 101 is wound in the spiral shape, sensor guides 107 are located as needed. Sensor guides 107 allow temperature sensor 101 to expand in a linear fashion as a response to temperature change, while maintaining the boundaries of the spiral shape. In response to the temperature change, the position of trigger ring 106 changes, the consequences of which will be further explained below.

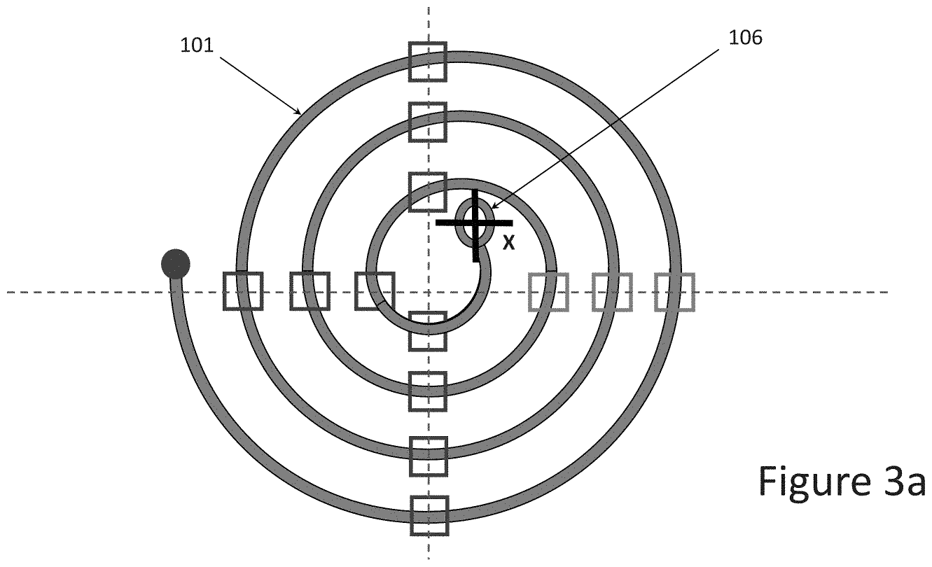

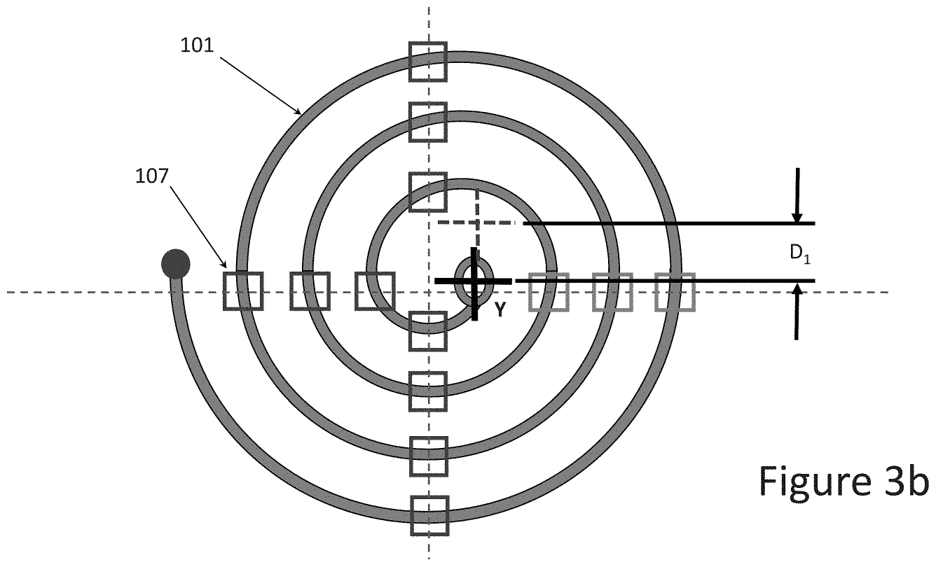

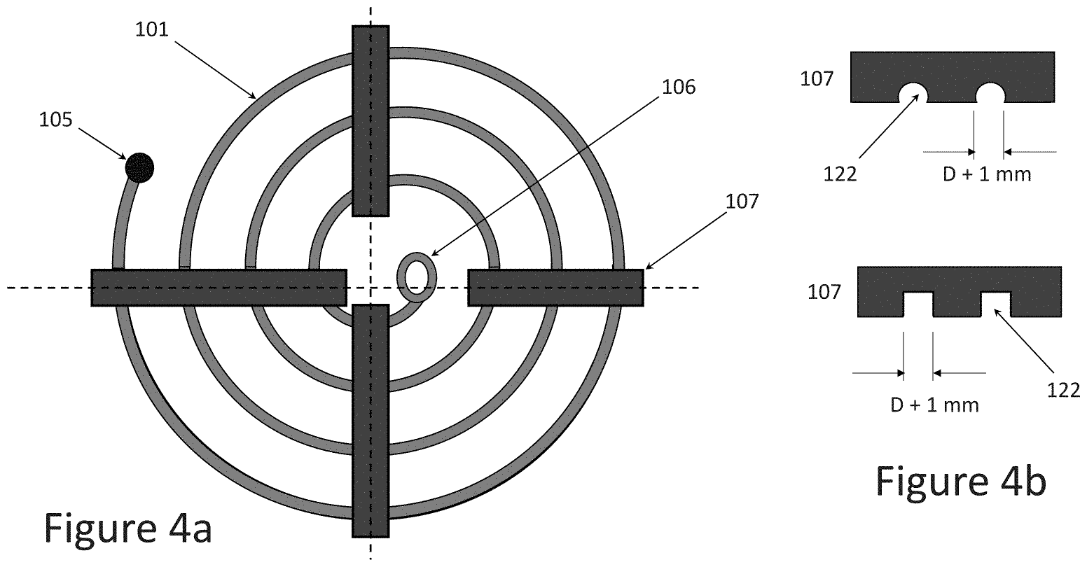

Turning to FIG. 3a, temperature sensor 101 is in a “warm” or “hot” state. Trigger ring 106 is in a first position, designated “X”. Turning to FIG. 3b, temperature sensor 101 is now in a “cool” or “cold” state. Temperature sensor 101 has contracted. Outer tube 104 will have contracted very little, while inner wire 102 will have contracted to a greater extent. As discussed above, sensor guides 107 allow the spiral shape to be maintained as outer tube 104 contracts. As inner wire 102 contracts, trigger ring 106 moves from the first position to a second position, designed “Y”. The difference between these positions indicates the total contraction of temperature sensor 101. FIGS. 4a and 4b illustrate two, non-limiting, embodiments of sensor guides 107. Sensor guides 107 may comprise several blocks with rectilinear or curved slots 122 which are sized slightly larger than the outer diameter of outer tube 104. The width (or diameter) of sensor guide slots 122 may be 1 mm greater than the outer diameter of outer tube 104. There may be four sensor guide slots 122 located uniformly around the spiral. There may be three sensor guide slots 122 located uniformly around the spiral (not shown).

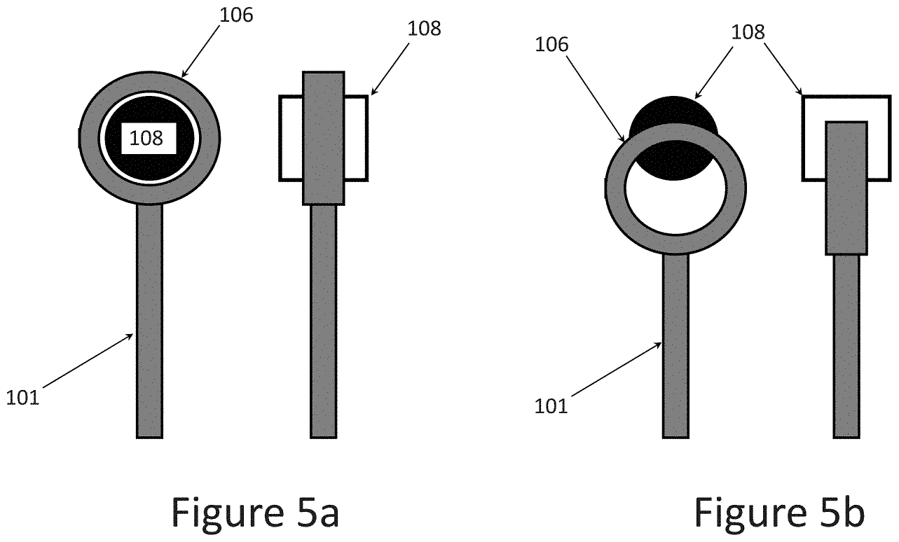

Turning to FIGS. 5a and 5b, details of trigger ring 106 are shown. Trigger 108 will be attached to a drain plug (described below). If circumstances are such that it is desirable for the drain plug to move (i.e. to allow the associated basin to drain), trigger ring 106 should be in the position indicated in FIG. 5a. Such a position will allow trigger 108 to move freely within trigger ring 106. If circumstances are such that it is undesirable for the drain plug to move (i.e. to not allow the associated basin to drain), trigger ring 106 should be in the position indicated in FIG. 5b. Such a position will not allow trigger 108 to move freely within trigger ring 106.

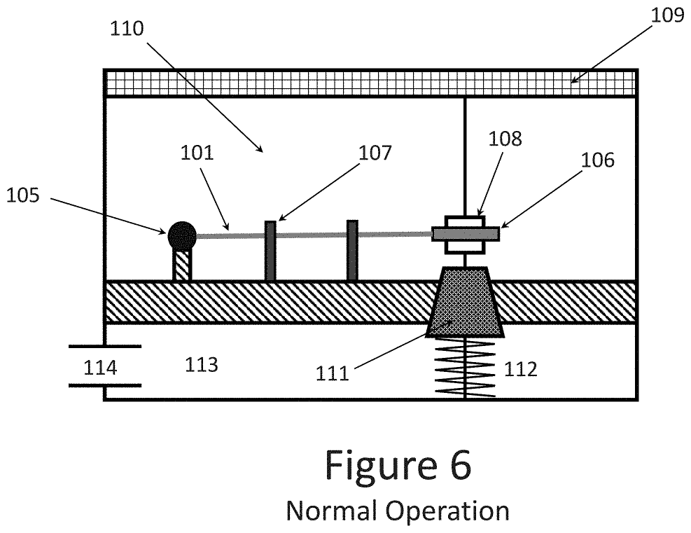

Turing to FIGS. 6, 7, and 8, the basic operation of the system is described. As indicated in FIG. 6, a storm water, or rainwater, basin has a grate 109 which will keep large objects and debris out of the interior collection chamber 110. A temperature sensor 101 has an anchor point 105, sensor guides 107, and a trigger ring 106, as generally described above. Within the collection chamber 110, drain plug 111 is positioned, and held in place by drain plug spring 112. Trigger 108 is attached to drain plug 111, and functions as an on-off switch. Beneath drain plug 111 is an outlet chamber 113, wherein the rainwater collects and exits though outlet 114. Under normal, dry conditions, trigger 108 is in a position within trigger ring 107, free to move if necessary.

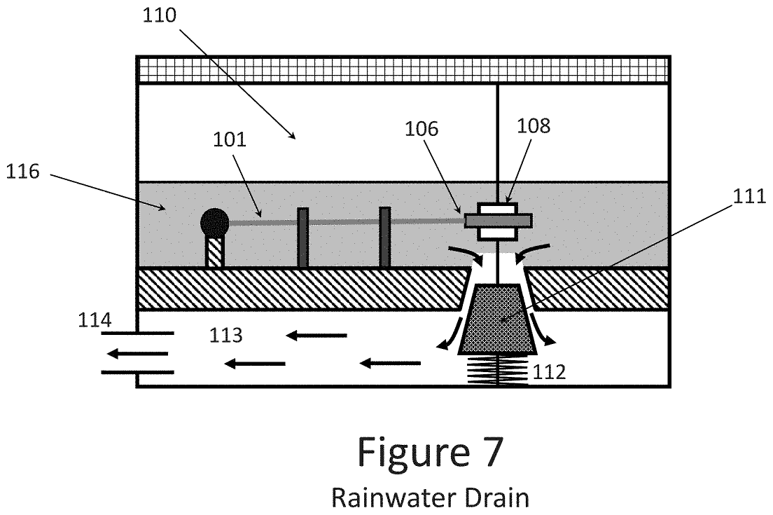

Turning to FIG. 7, the normal operation of the rainwater basin is described. Rainwater 116 collects within collection chamber 110. When a predetermined amount of water is present, the force provided by the weight of the water on drain plug 111, will cause drain plug spring 112 to compress. As the rainwater is not sufficiently cold to have caused temperature sensor 101 to significantly contract, trigger ring 106 is still in a position to allow trigger 108 to move. Therefore, plug 111 moves downward, allowing rainwater to enter outlet chamber 113 and exit through outlet 114.

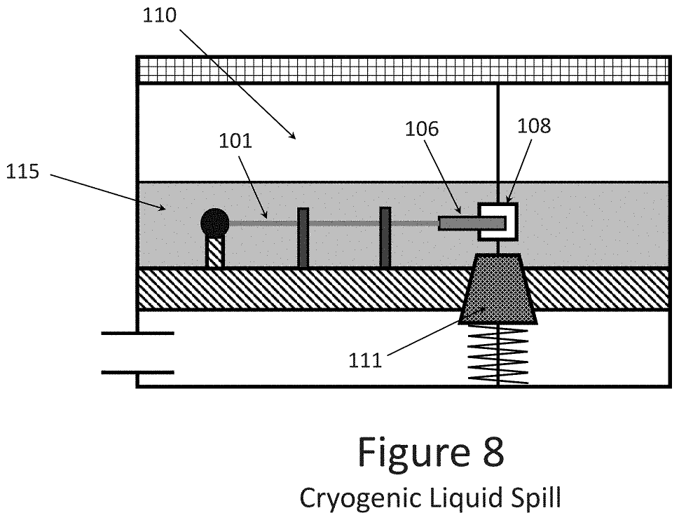

Turning to FIG. 8, the abnormal operation of a cryogenic liquid spill is described. Cryogenic liquid 115 enters and collects within collection chamber 110. Cryogenic Liquid 115 is sufficiently cold to cause temperature sensor 101 to significantly contract. This contraction of temperature sensor 101 will cause trigger ring 106 to move and now be in a position to not allow trigger 108 to move. No matter the extent of the spill, the pressure exerted by cryogenic liquid 115 will not be sufficient to compress drain plug spring 112 and allow cryogenic liquid 115 to exit the basin. Cryogenic liquid 115 will be held in collection chamber 110 until it evaporates and dissipates.

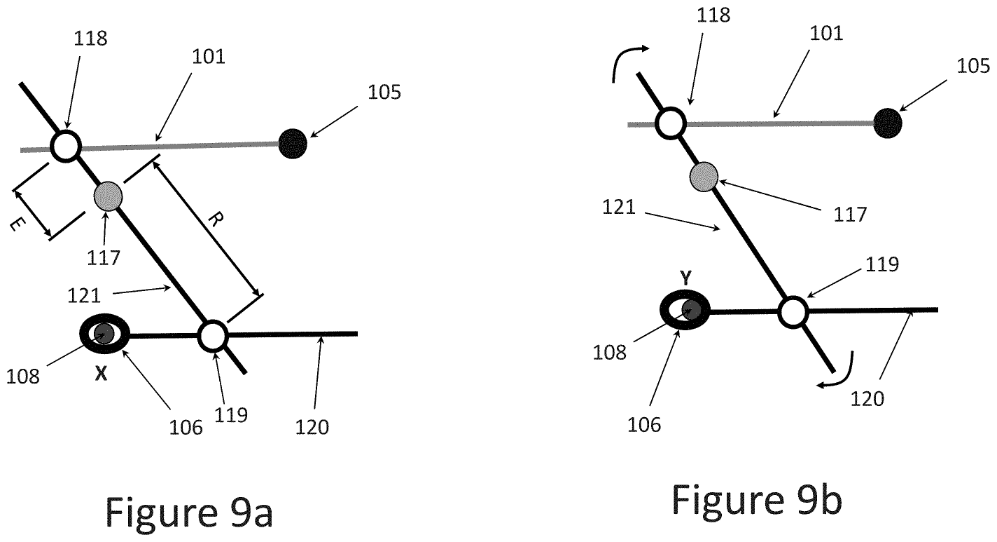

Turning to FIGS. 9a and 9b, another embodiment of temperature sensor 101 is presented. In this embodiment, temperature sensor 101 utilizes a micro-displacement, or motion, magnifier. This shape basically uses the principle of displacement multiplication by means of a simple lever.

Again, one end of temperature sensor 101 is fixed at anchor point 105. As temperature sensor 101 contracts, it moves first sliding point 118. First sliding point 118 is fixedly attached to temperature sensor 101, but moves, or slides, along lever 121. As first sliding point 118 moves along lever 121, it “pulls” lever 121 along with it, causing it to pivot at hinge point 117. First sliding point 118 has a first distance of E from hinge point 117. This, in turn, causes second sliding point 119 to slide along lever 121. Second sliding point 119 has a first distance of R from hinge point 117. Trigger bar 120 is fixedly attached to lever 121, and thus is “pulled” by trigger bar 120. Since trigger bar 120 is attached to trigger ring 106, trigger ring 106 then moves into position blocking the movement of trigger 108.

Turning to FIG. 9a, temperature sensor 101 is in a “warm” or “hot” state. Trigger ring 106 is in a first position, designated “X”. Turning to FIG. 9b, temperature sensor 101 is now in a “cool” or “cold” state. Temperature sensor 101 has contracted. As inner wire 102 contracts, trigger ring 106 moves from the first position to a second position, designed “Y”. The difference between these positions indicates the total contraction of temperature sensor 101. This total contraction of temperature sensor 101 is multiplied by the ratio of R/E, and the result is the amount that second sliding point 119 is displaced. This is also the distance that trigger ring 106 is displaced, thus blocking trigger 108 from moving.

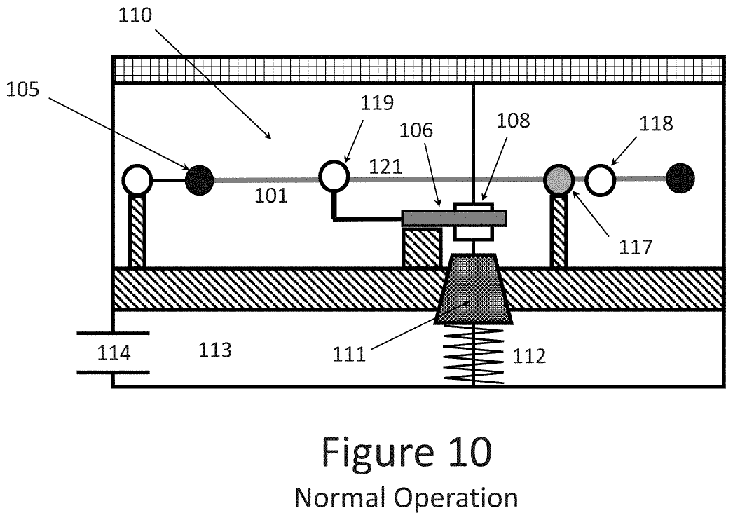

Turing to FIGS. 10, 11, and 12, the basic operation of the system is described. As indicated in FIG. 10, a storm water, or rainwater, basin has an interior collection chamber 110. A temperature sensor 101 has an anchor point 105, hinge point 117, first sliding point 118, second sliding point 119, trigger bar 120, and a trigger ring 106, as generally described above. Within the collection chamber 110, drain plug 111 is positioned, and held in place by drain plug spring 112. Trigger 108 is attached to drain plug 111, and functions as an on-off switch. Beneath drain plug 111 is an outlet chamber 113, wherein the rainwater collects and exits though outlet 114. Under normal, dry conditions, trigger 108 is in a position within trigger ring 107, free to move if necessary.

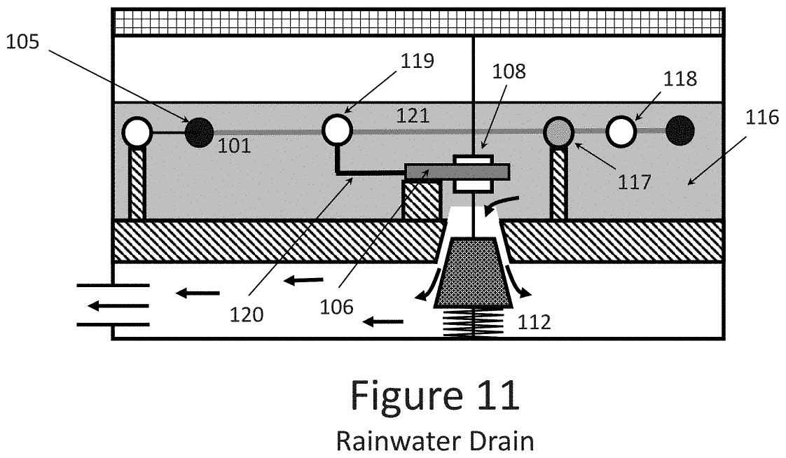

Turning to FIG. 11, the normal operation of the rainwater basin is described. Rainwater 116 collects within collection chamber 110. When a predetermined amount of water is present, the force provided by the weight of the water on drain plug 111, will cause drain plug spring 112 to compress. As the rainwater is not sufficiently cold to have caused temperature sensor 101 to significantly contract, trigger ring 106 is still in a position to allow trigger 108 to move. Therefore, plug 111 moves downward, allowing rainwater to enter outlet chamber 113 and exit through outlet 114.

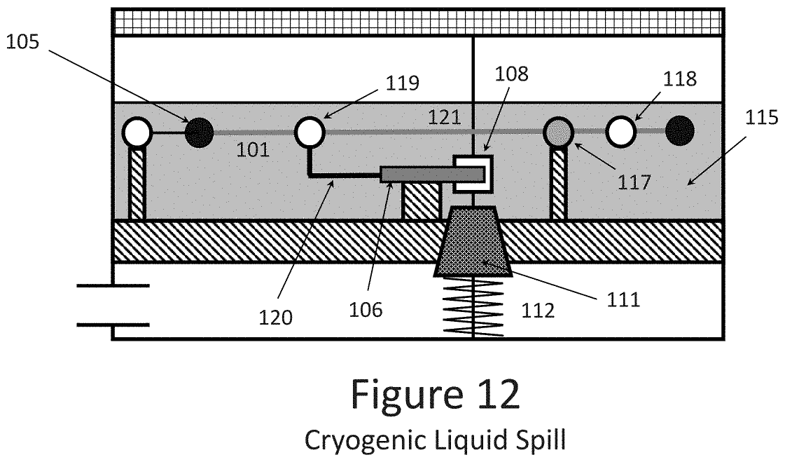

Turning to FIG. 12, the abnormal operation of a cryogenic liquid spill is described. Cryogenic liquid 115 enters and collects within collection chamber 110. Cryogenic Liquid 115 is sufficiently cold to cause temperature sensor 101 to significantly contract. This contraction of temperature sensor 101 will cause trigger ring 106 to move and now be in a position to not allow trigger 108 to move. No matter the extent of the spill, the pressure exerted by cryogenic liquid 115 will not be sufficient to compress drain plug spring 112 and allow cryogenic liquid 115 to exit the basin. Cryogenic liquid 115 will be held in collection chamber 110 until it evaporates and dissipates.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. An apparatus for controlling fluid flow, comprising:
a temperature sensitive material, comprising a first physical property at a first temperature and a second physical property at a second temperature,
a device for controlling fluid flow,
a device for connecting the temperature sensitive material to the fluid flow control device,
wherein the connecting device is configured so that the fluid flow control device is in a first position at the first temperature and in a second position at a second temperature.

2. The apparatus of claim 1, wherein the temperature sensitive material is aluminum wire or stainless steel wire.

3. The apparatus of claim 2, wherein the temperature sensitive material comprises the shape of an Archimedean spiral.

4. The apparatus of claim 1, wherein the connecting device is a motion amplifier.

5. The apparatus of claim 1, wherein the first temperature is a cryogenic temperature.

6. The apparatus of claim 1, wherein the first temperature is less than about −150 C.

7. The apparatus of claim 1, wherein the first temperature is less than about −173 C.

8. The apparatus of claim 1, wherein the first temperature is less than about −196 C.

9. The apparatus of claim 1, wherein the second temperature is ambient temperature.

10. The apparatus of claim 1, wherein the second temperature is greater than 0 C.

11. The apparatus of claim 1, wherein the second temperature is greater than 20 C.

12. The apparatus of claim 1, wherein the connecting device is configured to hold the fluid controlling device captive in the first position, and to release the fluid controlling device in the second position.
